(19) United States
(12) Patent Application Publication
(10) Pub. No.: US 2005/0229764 A2
(43) Pub. Date: Oct. 20, 2005

(54) Cutting Tool for Belts

(75) Inventor: Volkmar Voigtlander, Hamburg (DE)

Correspondence Address: VENABLE LLP, P.O. BOX 34385, WASHINGTON, DC, 44118, US

(73) Assignee: E.C.H. Will GmbH, Hamburg (DE)

(21) Appl. No.: 10/647,465

(22) Filed: Aug. 26, 2003

(51) Int. Cl. B26D 1/00

(52) U.S. Cl. 83/651; 83/935

(57) ABSTRACT

Abstract of the Disclosure

A cutting tool for belts has a zigzag cutting structure with at least three cutting edges. Respectively two adjacent and transverse cutting edges are joined at a common end.

### Detailed Description of the Invention

### CROSS-REFERENCE TO RELATED APPLICATION

This application claims the priority of German Patent Application No. 102 40 005.9 filed on August 27, 2002 the disclosure of which, together with the disclosure of each U.S. and foreign patent and patent application mentioned below, is incorporated herein by reference.

### BACKGROUND OF THE INVENTION

The invention relates to a cutting tool for belts.

Large and small belts are used for machinery in the paper-processing industry, for the treatment and transport of paper sheets and/or paper stacks. The belts are closed and endless. In addition, the transport belts are elastic and are preferably made of rubber or plastic. The two ends of a finite belt must be joined to form an endless belt.

A drive belt made of polyamide, including a method for producing an end connection on the drive belt, is described in German patent document DE-A-39 33 710. The belt ends are provided with zigzag structures that complement each other and the contact surfaces are then coated with a solution. The abutting belt ends are subsequently clamped into a clamping device, such that the contact surfaces can be glued together under pressure.

A cutting tool for making triangular cuts in an elastic material, preferably an insulating material, is described in German patent document DE-A-197 56 047. The cutting tool consists of two cutting plates arranged at an angle to each other. Cutting edges of the cutting plates are respectively formed by grinding the outer surfaces on one side. This cutting tool, however, is not suited for forming complementing zigzag structures on the belt ends to enable the two belt ends to be joined.

### BRIEF SUMMARY OF THE INVENTION

It is an object of the present invention to improve the production and processing of belts, in particular belts used for machinery in the paper-processing industry.

This and other objects are solved with a cutting tool for belts, which cuts a zigzag-type structure and comprises at least three cutting edges, wherein respectively two transverse arranged cutting edges share a common end point.

In contrast to the prior art, in which two or more working steps are required to create zigzag structures that complement each other in form and function, respectively one zigzag structure is formed on the belt end with the cutting tool in accordance with the invention in one operational step. A cutting operation with the cutting tool of the present invention results in belt ends that overlap in this case such that the ends can fit together precisely. According to the invention, each cutting edge extends between two end points. At least one end point of the one cutting edge simultaneously also functions as the end point for another, transversely extending adjacent cutting edge. The ends of the cutting edges adjoin directly or make direct contact.

A simple tool design is achieved if the cutting edges are respectively created on a cutting plate. The individual cutting plates enable an adaptable cutting tool that can be designed with different widths. In addition, a dull cutting plate can thus be easily replaced. On the whole, the design and production of a cutting tool comprising individual cutting plates is made easier and has a high degree of variability.

The cutting edges are preferably embodied as crosscutters. The term "crosscutter" is understood to mean, in particular, a cutting edge embodied as a diagonal cutting edge on a basic body. In this regard, the cutting edge does not extend parallel to or along a longitudinal side of the basic body.

According to an exemplary embodiment of the invention, the cutting edges are formed by an intersection of at least two asymmetrical cutting edge surfaces. The asymmetry of the cutting edge surfaces is achieved by designing the cutting edge to extend transverse to the longitudinal axes of, for example, a cutting plate.

The processing of a cutting plate is simplified if the cutting edge surfaces are arranged symmetrical, in particular axially symmetrical, to each other. The cutting edge surfaces are created through a two-sided asymmetric grinding of a plate edge in which the cutting plate can initially be ground asymmetrically from one side. The other side is then ground by rotating the cutting plate around a rotational axis. This process creates the diagonally extending cutting edges (or “crosscutters”) on a cutting plate.

According to a further exemplary embodiment, the cutting tool is configured such that the cutting plates and/or the cutting edges are arranged symmetrical, in particular mirror-symmetrical, to each other. As a result, the non-ground edges of cutting blade edges of the cutting plates are arranged next to each other in pairs and form the points of the zigzag structure for the cutting tool.

According to another exemplary embodiment of the invention, the cutting tool is formed with two types of cutting plates to facilitate the design and fabrication of the cutting tool since the two types of cutting plates are alternately arranged next to each other and side-by-side. For this, the cutting tool is designed with the cutting plates disposed at a predetermined, opening angle to each other.

The cutting edges can be hardened to permit continuous cutting or punching with the tool in accordance with the invention.

In another exemplary embodiment, the cutting tool and/or the cutting plates are made of metal, and in particular, of steel.

In accordance with another exemplary embodiment of the invention, the cutting tool is utilized for the processing of belts, in particular belts for machinery used in the paper-processing industry.

### BRIEF DESCRIPTION OF THE DRAWINGS

The invention is described in the following without restricting the general inventive idea, with the aid of exemplary embodiments and by referring to the drawings, to which we reference is made for all details of the invention not explicitly explained in the text.

Figure 1 is a perspective view of a cutting tool in accordance with the present invention.

Figure 2 is a plan view of the cutting tool shown in Figure 1.

Figures 3a to 3d are different views of a first cutting plate used in the cutting tool shown in Figure 1.

Figures 4a to 4d are different views of a second cutting plate used in the cutting tool shown in Figure 1.

### DETAILED DESCRIPTION OF THE INVENTION

In Figures described herein, identical elements are provided with the same reference numbers and will not be introduced anew in each case.

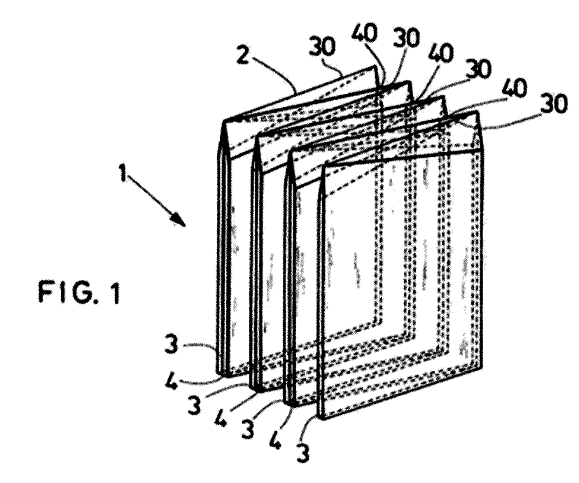

Referring to Figure 1, covered and non-visible edges of a cutting tool 1 in accordance with the present invention are respectively shown with dashed lines in order to clearly show the spatial configuration of the cutting tool 1. The cutting tool 1 includes at least two different types of cutting plates 3, 4 which are arranged alternately and at a specific opening angle to each other. Each of the cutting plates 3, 4 is provided with respectively one cutting edge 30, 40 on the top of the plate. The cutting edges 30, 40 of the respective cutting plates 3, 4 are arranged so as to form a zigzag structure 2.

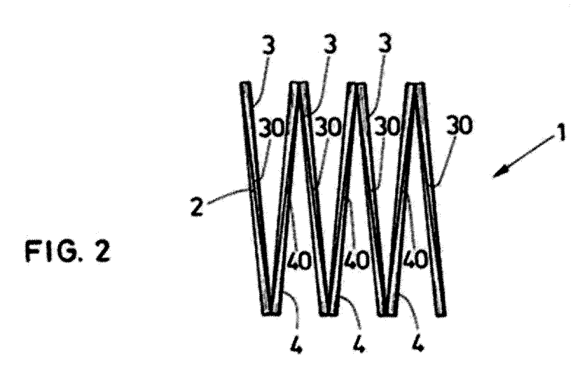

As shown in Figure 2, the cutting edges 30, 40 of cutting plates 3, 4 respectively extend transverse to the rectangular basic surface of the respective cutting plate to thus form a crosscutter or cross-cutting blade. The cutting edge 30, 40 extends between the diagonally oppositely-arranged end points. The end point for the cutting edge 30 also forms the end point of the adjacent cutting edge 40 that is disposed at a predetermined angle to the cutting edge 30. The ends of the cutting edges 30, 40 make direct contact and/or adjoin directly.

The cutting tool 1 includes two different types of cutting plates, i.e., the cutting plate 3 and the cutting plate 4. The cutting plate 3 is designed to be mirror-symmetrical to the cutting plate 4.

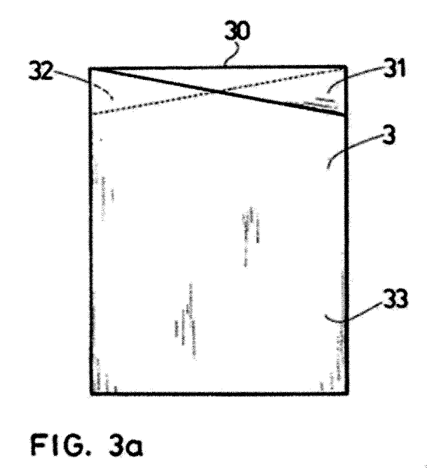

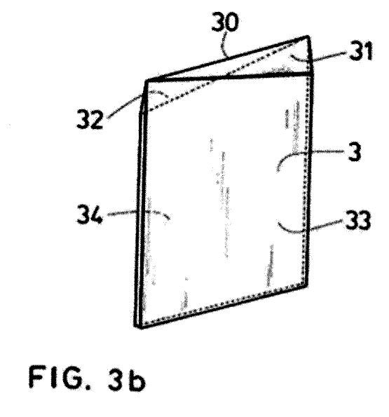

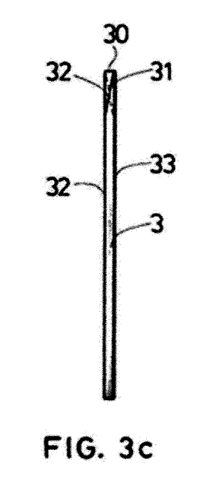

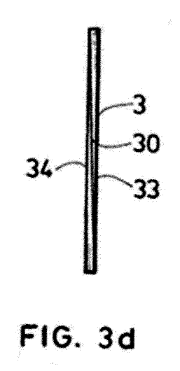

Referring to Figures 3a-3d, the cutting plate 3 is provided with a triangular, asymmetrical cutting edge surface 31 on a front side 33 of the cutting plate 3 in which the cutting edge 30 forms one edge of the cutting edge surface 31. A triangular, asymmetric cutting edge surface 32 is also formed on a back side 34 of the cutting plate 3 in which the cutting edge 30 again forms one edge of the triangular cutting edge surface. The cutting edge surface 31 and the cutting edge surface 32 are arranged axially symmetrical to each other such that the cutting edge 30 is embodied as a diagonally extending cutting edge.

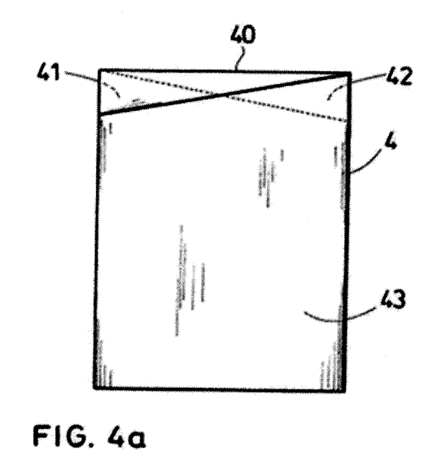

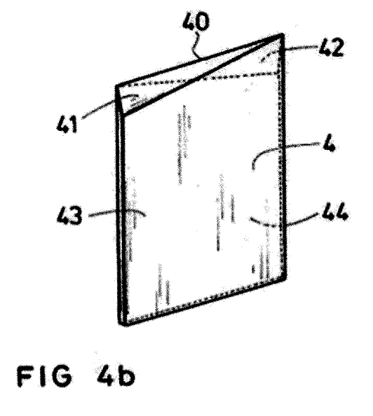

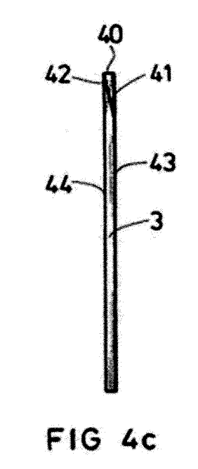

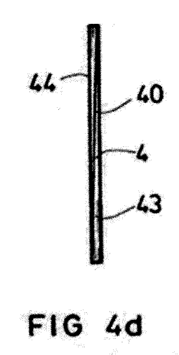

Figures 4a to 4d show various views of the cutting plate 4 that correspond to the representations of the cutting plate 3 in Figures 3a to 3d. In the cutting structure, the cutting plate 4 is mirror-symmetrical to the cutting plate 3. The cutting plate 4 has a triangular cutting edge surface 41 on a front side 43. On a back side 44, the cutting plate 4 has a cutting edge surface 42 that is arranged axially symmetrical to the cutting edge surface 41.

The invention has been described in detail with respect to exemplary embodiments, and it will now be apparent from the foregoing to those skilled in the art, that changes and modifications may be made without departing from the invention, therefore, as defined in the appended claims, is intended to cover all such changes and modifications that will fall within the true spirit of the invention.

1. A cutting tool for belts, comprising:
a zigzag cutting structure having at least three cutting edges,
wherein respectively two adjacent and transverse cutting edges are joined at a common end.

2. The cutting tool according to claim 1, wherein the cutting structure is formed by a plurality of cutting plates, each cutting edge being formed on a single cutting plate.

3. The cutting tool according to claim 1, wherein the cutting edges are cross cutters.

4. The cutting tool according to claim 1, wherein each cutting edge is formed by an intersection of at least two asymmetrical cutting edge surfaces.

5. The cutting tool according to claim 4, wherein the cutting edge surfaces at the respective cutting edge are arranged symmetrical to one another.

6. The cutting tool according to claim 5, wherein the cutting edge surfaces at the respective cutting edge are arranged axially symmetrical to one another.

7. The cutting tool according to claim 1, wherein the cutting edge is arranged symmetrical to the adjacent cutting edge.

8. The cutting tool according to claim 6, wherein the cutting edge is arranged mirror symmetrical to the adjacent cutting edge.

9. The cutting tool according to claim 2, wherein the cutting structure is formed by two types of cutting plates.

10. The cutting tool according to claim 2, wherein the cutting plate is arranged mirror symmetrical to the adjacent cutting plate.

11. The cutting tool according to claim 1, wherein the cutting edges are hardened.

12. The cutting tool according to claim 1, wherein the cutting structure is metal.

13. The cutting tool according to claim 10, wherein the metal is steel.

14. A method for cutting belts which comprises utilizing the cutting tool of claim 1.
